(19) United States
(12) Patent Application Publication
(10) Pub. No.: US 2022/0382430 A1
(43) Pub. Date: Dec. 1, 2022

(54) SHORTCUT KEYS FOR VIRTUAL KEYBOARDS

(71) Applicant: Citrix Systems, Inc., Fort Lauderdale, FL (US)

(72) Inventors: Sai Xu, Nanjing (CN); Taodong Lu, Nanjing (CN); Qin Zhang, Nanjing (CN)

(21) Appl. No.: 17/359,720

(22) Filed: Jun. 28, 2021

Related U.S. Application Data
(63) Continuation of application No. PCT/CN2021/095707, filed on May 25, 2021.

(51) Int. Cl. G06F 3/0489; G06F 3/0488

(52) U.S. Cl. CPC G06F 3/0489; G06F 3/04886

(57) ABSTRACT

In one aspect, an example methodology implementing the disclosed techniques includes, by a computing device, responsive to initiation of an application of the computing device, a display of which including a virtual keyboard, detecting, by the computing device, an input on a shortcut key of the virtual keyboard. The method also includes, by the computing device, translating the shortcut key into one or more keystrokes based on a configuration file for that short key and providing the one or more keystrokes to the application to execute a function of the shortcut key in response to the detected input.

### CROSS REFERENCE TO RELATED APPLICATION

This application is a continuation of and claims the benefit of PCT Patent Application No. PCT/CN2021/095707 filed on May 25, 2021 in the English language in the State Intellectual Property Office and designating the United States, the contents of which are hereby incorporated herein by reference in its entirety.

### BACKGROUND

Companies, enterprises, governments, agencies and other types of organizations may implement digital workspace solutions to allow users to access electronic resources, such as websites, web applications, software-as-a-service (SaaS) applications, virtual desktops, etc. Users (e.g., employees) may access electronic resources using personal computing devices and/or computing devices provided by an organization. The computing devices often provide a peripheral input device, such as a physical keyboard, so that users can interact with the computing devices. A “keyboard” generally refers to a user input device that has alphanumeric keys (including alphabetic keys and number keys) and possibly other keys, such as symbol keys, function keys, and shortcut keys. For example, a user can enter keystrokes or key presses on a keyboard provided by a computing device to interact with an electronic resource.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

As noted above, a user can enter keystrokes or key presses on a keyboard provided by a computing device to interact with an electronic resource (sometimes referred to herein more simply as a “resource”), such as an application. These keystrokes or key presses may include keyboard shortcuts. Keyboard shortcuts refer to keyboard inputs (combination of one or more keystrokes or key presses) which generate an instruction or a command to the computing device or an application or tool accessible using the computing device. Keyboard shortcuts are often generated by the user pressing a combination of keys on a physical keyboard. One example of a keyboard shortcut is the control key (CTRL) and the ‘B’ key being pressed at the same time which generates an instruction to change the selected text to bold. Another example of a keyboard shortcut is the control key (CTRL) and the ‘I’ key being pressed at the same time which generates an instruction to change the selected text to italics. Another example of a keyboard shortcut is the control key (CTRL) and the ‘X’ key being pressed at the same time which generates an instruction to cut the selected item. Using keyboard shortcuts, users can significantly improve efficiency when using the computing device to generate or edit documents and other content.

However, mobile computing devices (sometimes referred to herein more simply as “mobile devices” or a “mobile device” in the singular) typically provide virtual keyboards and do not provide physical keyboards. A virtual keyboard is a software component that allows the input of characters and is usually displayed on a touch screen of a mobile device. Virtual keyboards on mobile devices are typically small and limited in the number of keys that can be accommodated due to the small touchscreen area of these devices. As compared to computing devices that provide larger keyboards that are more functional in terms of features and usability, users of mobile devices may feel constrained in their use of the relatively small virtual keyboards. In particular, the users of these smaller virtual keyboards may feel constrained in the inability to use keyboard shortcuts which were commonly available when using the larger, more functional keyboards. This may be due to the limited number of keys that can be displayed or small size of the keys that are displayed. Moreover, even in cases where a virtual keyboard may include a toolbar that displays one or more function keys, the user may not have access to function keys which were available when the user used computing devices having larger, more functional keyboards (e.g., physical keyboards). Embodiments of the present disclosure provide solutions to these and other technical problems described herein.

In accordance with one example embodiment provided to illustrate the broader concepts, systems, and techniques described herein, a method may include, by a computing device, responsive to initiation of an application of the computing device, a display of which including a virtual keyboard, detecting, by the computing device, an input on a shortcut key of the virtual keyboard. The method may also include, by the computing device, translating the shortcut key into one or more keystrokes based on a configuration file for that shortcut key and providing the one or more keystrokes to the application to execute a function of the shortcut key in response to the detected input.

According to another illustrative embodiment provided to illustrate the broader concepts described herein, a mobile computing device includes a memory and one or more processors in communication with the memory. The processor may be configured to, responsive to initiation of an application of the mobile computing device, a display of which includes a virtual keyboard, detect an input on a shortcut key of the virtual keyboard. The processor may be further configured to translate the shortcut key into one or more keystrokes based on a configuration file for that shortcut key and provide the one or more keystrokes to the application to execute a function of the shortcut key in response to the detected input.

According to another illustrative embodiment provided to illustrate the broader concepts described herein, a method may include, by a computing device, receiving shortcut information and context information, the shortcut information including an indication of a shortcut key and one or more keystrokes that map to the shortcut key, the context information related to a context of the application, and generating a mapping between the shortcut key and the one or more keystrokes in a shortcut configuration file associated with both a user and an application, the mapping including information related to a displaying of the shortcut key. The method may also include, by the computing device, responsive to a request for the shortcut configuration file, providing the shortcut configuration file for use in displaying the shortcut key on a virtual keyboard.

According to another illustrative embodiment provided to illustrate the broader concepts described herein, a system includes a memory and one or more processors in communication with the memory. The processor may be configured to receive shortcut information and context information, the shortcut information including an indication of a shortcut key and one or more keystrokes that map to the shortcut key, the context information related to a context of the application, and generate a mapping between the shortcut key and the one or more keystrokes in a shortcut configuration file associated with both a user and an application, the mapping including information related to a displaying of the shortcut key. The processor may be further configured to, responsive to a request for the shortcut configuration file, provide the shortcut configuration file for use in displaying the shortcut key on a virtual keyboard.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a block diagram of an illustrative network environment in which mobile devices can present shortcut keys in a virtual keyboard, in accordance with an embodiment of the present disclosure.

FIGS. 6A-6D illustrate presenting of shortcut keys in a virtual keyboard, in accordance with an embodiment of the present disclosure.

FIG. 7 is a sequence diagram showing an example flow of interactions between various components to generate a shortcut configuration file, in accordance with an embodiment of the present disclosure.

FIG. 8 is a sequence diagram showing an example flow of interactions between various components to present shortcut keys in a virtual keyboard, in accordance with an embodiment of the present disclosure.

### DETAILED DESCRIPTION

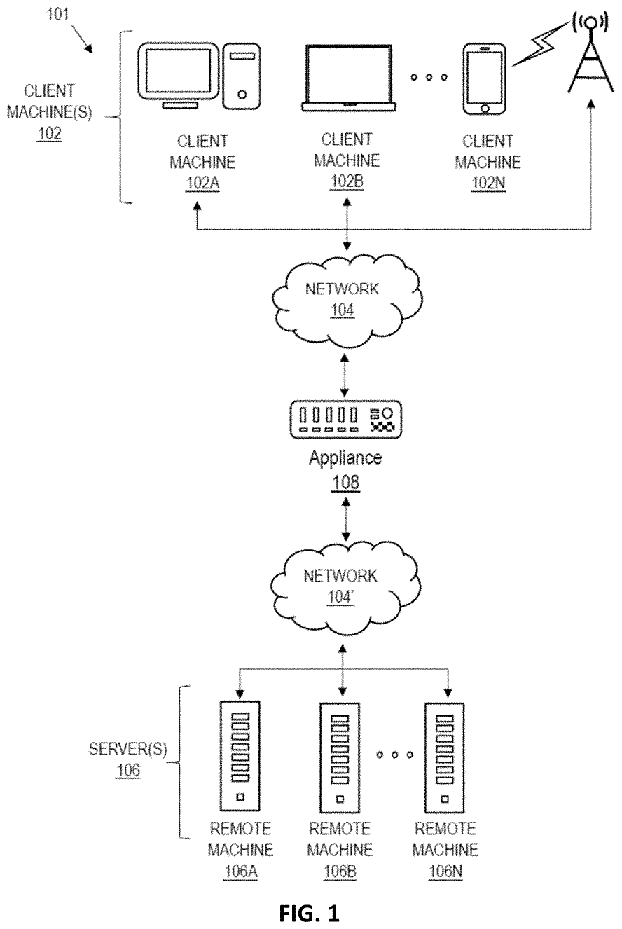

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

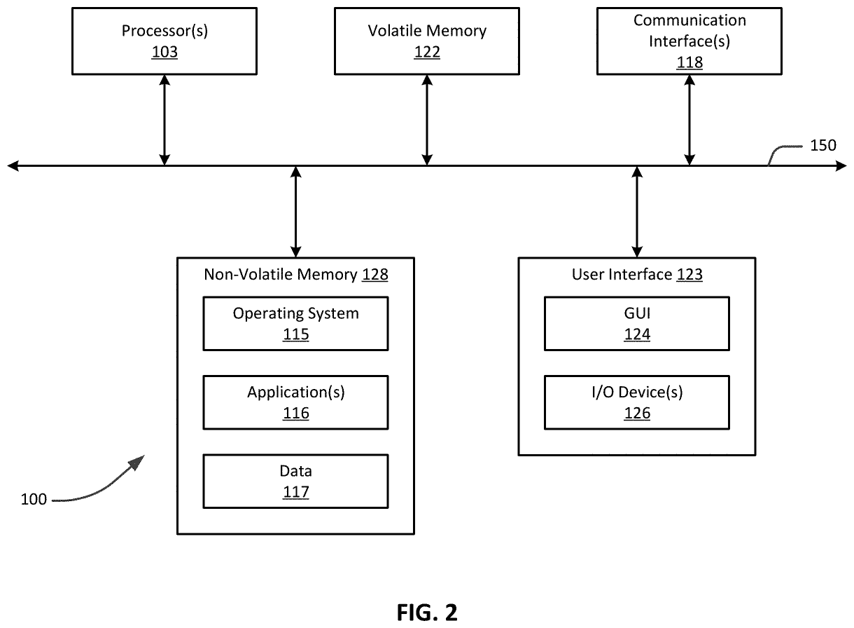

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

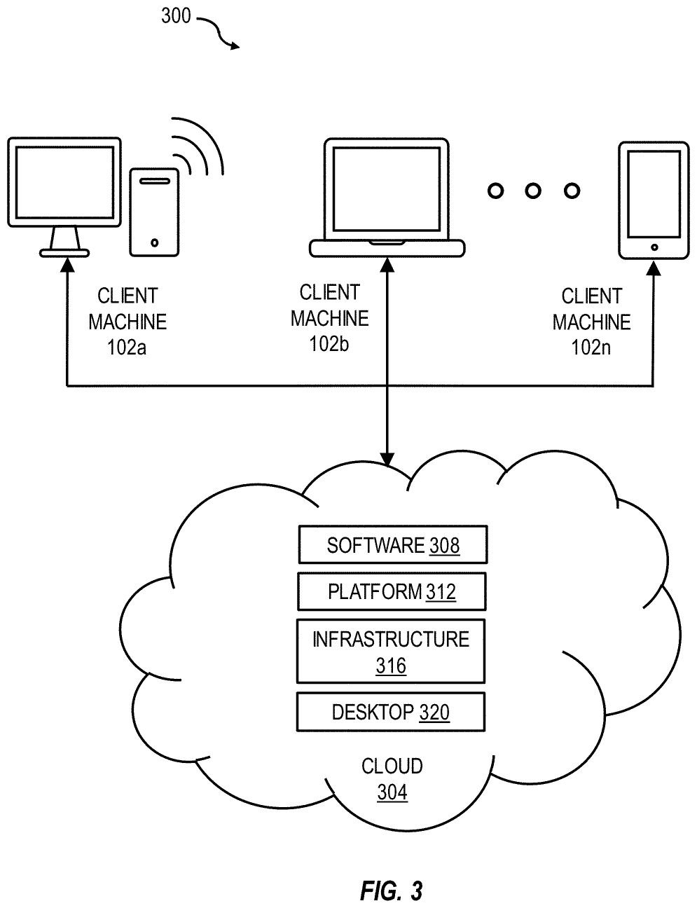

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif..

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g., Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

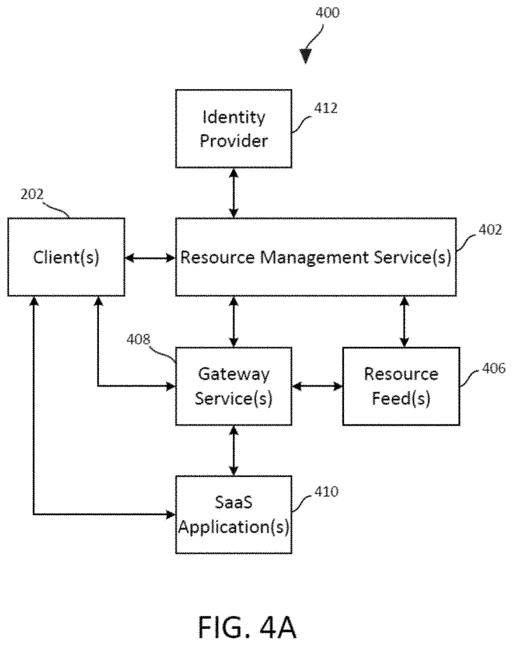

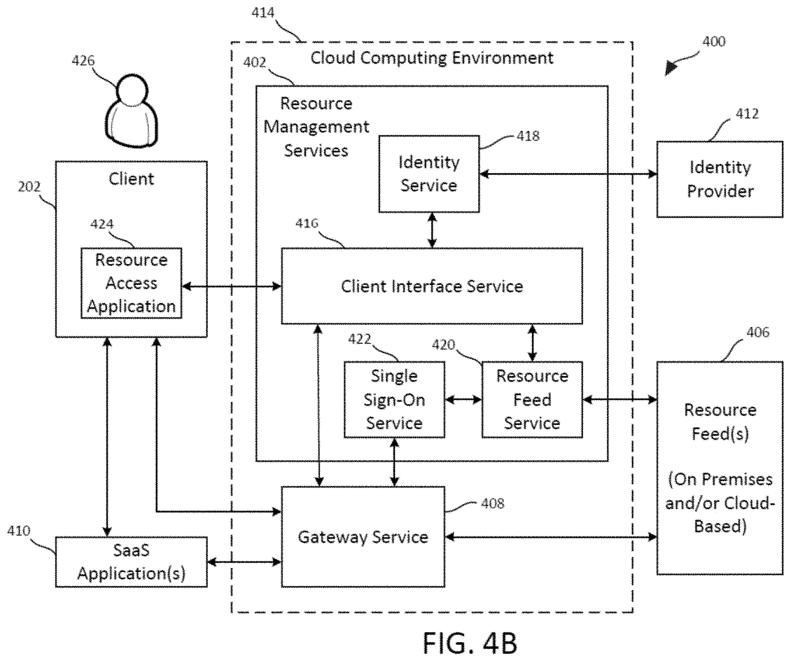

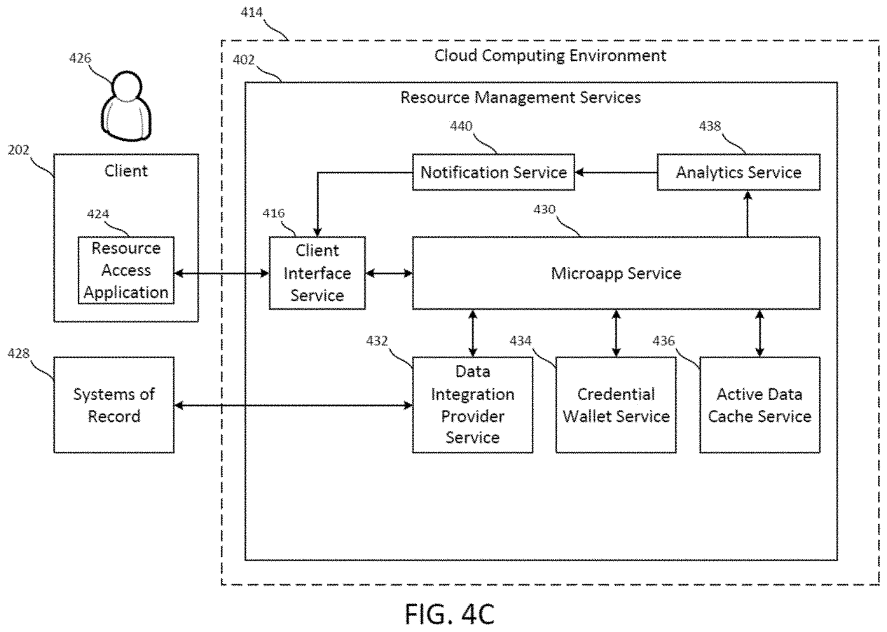

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (Al) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

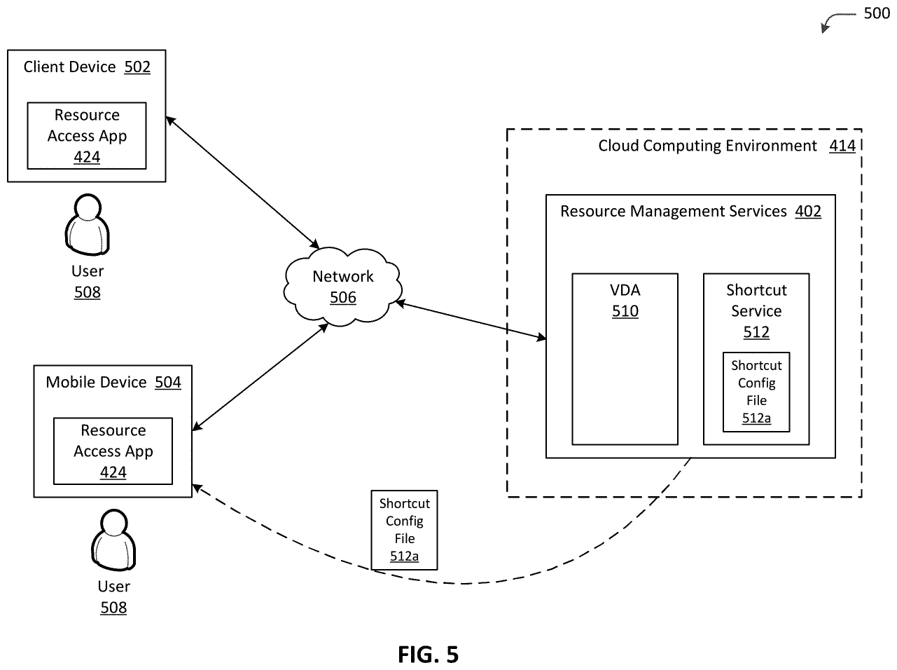

FIG. 5 is a block diagram of an illustrative network environment 500 in which mobile devices can present shortcut keys in a virtual keyboard, in accordance with an embodiment of the present disclosure. In brief, a client device, such as a mobile device, can be understood as providing context dependent shortcut keys that are presented in a virtual keyboard on a touchscreen of the client device. In FIG. 5, like elements of system 400 of FIGS. 4A-4C are shown using like reference designators. As such, the previous relevant discussion with respect to features of the like elements shown using like reference designators is equally applicable here, including the previous relevant discussion with respect to client 202, resource access application 424, resource management services 402, and cloud computing environment 414.

As shown in FIG. 5, network environment 500 can include one or more client devices 502, one or more mobile devices 504, and resource management services 402 communicably coupled to one another via a network 504. Network 504 may correspond one or more to wireless or wired computer networks including, but not limited to, local-area networks (LANs), metropolitan area networks (MANs), wide area networks (WANs), wireless local-area networks (WLAN), primary public networks, primary private networks, cellular networks, Wi-Fi (i.e., 802.11) networks, Bluetooth networks, and Near Field Communication (NFC) networks. In some embodiments, network 504 may include another network or a portion or portions of other networks.

Network environment 500 may provide services for one or more organizations, with the organizations having one or more users associated with it. A given client device 502 and a given mobile device 504 may be assigned to or otherwise associated with a particular user. For example, as shown in FIG. 5, client device 502 and mobile device 504 may be assigned to, or otherwise associated with, a user 508. While only one client device 502, one mobile device 504, and one corresponding user 508 are shown in FIG. 5, the structures and techniques sought to be protected herein can be applied to any number of organizations, users, and devices.

Client device 502 can include laptop computers, notebook computers, desktop computers, workstations, or other computing devices that execute desktop operating systems (i.e., non-mobile operating systems) and which are configured to run desktop user applications (or “apps”). Such devices typically provide physical keyboards that are more functional in terms of features and usability than the smaller virtual keyboards provided by mobile devices. In some embodiments, client device 502 may be substantially similar to client machine 102 described above in the context of FIGS. 1 and 3, computing device 100 described above in the context of FIG. 2, and/or client 202 described above in the context of FIGS. 4A-4C.

Mobile device 504 can include smartphones, cellular/mobile phones, tablet computers, and other handheld computing devices that execute mobile operating systems and which are configured to run mobile user applications (or “apps”). Such devices provide virtual keyboards and do not typically provide physical keyboards. In some embodiments, mobile device 504 may be substantially similar to client machine 102 described above in the context of FIGS. 1 and 3, computing device 100 described above in the context of FIG. 2, and/or client 202 described above in the context of FIGS. 4A-4C.

With continued reference to, and as shown in FIG. 5, user 508 may access resource management services 402 and other services and network resources (e.g., SaaS applications and web applications) using resource access application 424 installed on client device 502. Similarly, user 508 may also access resource management services 402 and other services and network resources (e.g., SaaS applications and web applications) using resource access application 424 installed on mobile device 504. Resource management services 402 may manage and streamline access to enterprise resources provided by an organization for access and use by users associated with the organization. Resource access application 424 and associated components may provide user 508 with a personalized, all-in-one interface enabling seamless access to the user's resources, such as SaaS and web applications, files, virtual Windows applications, virtual Linux applications, desktops, mobile applications, Citrix Virtual Apps and Desktops™, local applications, and other data. In one example, resource access application 424 may be the CITRIX WORKSPACE app. In an implementation, resource access application 424 may include a web browser for accessing web-based SaaS applications along with other types of web apps and websites.

Resource management services 402 may include one or more virtual delivery agents (VDAs) 510. VDA 510 may be installed on and execute on the individual physical or virtual machine that is hosting the resources. In embodiments, VDA 510 serves as an agent that allows the machine and the resources hosted by the machines to be made available to users. VDA 510 enables users to connect to the resources (e.g., applications) being hosted on the machine. To this end, VDA 510 is configured to provide various virtual desktop access services such as, by way of example, user access authentication and management, user session management, resource brokering and provisioning, and application of policies configured for the session.

Certain of the embodiments disclosed herein overcome the drawbacks of traditional virtual keyboards by implementing context dependent shortcuts which can be presented in a virtual keyboard that is provided to a user for interacting with a resource. For example, when a user uses a computing device that provides a physical keyboard (i.e., a keyboard that is more functional in terms of features and usability than a virtual keyboard provided by a mobile device) to connect to and access an application, the keyboard inputs made by the user to interact with the application can be monitored to detect the use of shortcuts (e.g., ‘bold’, ‘strikethrough’, ‘find’, ‘replace’, ‘copy’, ‘cut’, ‘paste’, ‘select text’, etc.). The shortcuts used by the user during the user's interaction with the resource (e.g., during the user session using the application) may be recorded or logged for later use. For example, shortcut mappings (i.e., mappings between the shortcuts and the one or more keystrokes that are input to initiate the individual shortcuts) may be recorded in a shortcut configuration file that is specific to the user and the application into which the shortcut was input.

As a result, when the user opens an application using a mobile device, the shortcuts that were recorded during the user's prior use of the same application using a non-mobile device (i.e., a computing device that provides a more functional keyboard), may be provided to the mobile device for use by the user. For example, the shortcut configuration file that is specific to the user and the application being accessed by the user may be provided to the mobile device. The mobile device can then present one or more shortcut keys (e.g., icons or user interface (UI) elements) in a virtual keyboard for use by the user. These shortcut keys may represent the shortcuts and may be presented in the virtual keyboard based on the information contained in the shortcut configuration file. As an example, information in the shortcut configuration file may indicate that the ‘cut’ shortcut is typically used after the use of the ‘select text’ shortcut. In this example, based on this information, a ‘Cut’ shortcut key that represents the cut shortcut may be presented in the virtual keyboard upon detecting the use of the ‘select text’ shortcut. As another example, information in the shortcut configuration file may indicate the user's favorite shortcut or shortcuts when using the specific application. As still another example, information in the shortcut configuration file may indicate when to display a specific shortcut key or keys in a virtual keyboard. As another example, information in the shortcut configuration file may indicate the position or location in the virtual keyboard at which a specific shortcut is to be presented. The mobile device may also periodically or continually update the presentation of the shortcut keys in the virtual keyboard, for example, based on the application context. In general, this provides a user using a mobile device to interact with resources an improved user experience since the user is provided with the ability to use shortcuts which have been previously used and familiar to the user.

To this end, as can be seen in FIG. 5, resource management services 402 may include one or more virtual delivery agents (VDAs) 510 and a shortcut service 512. VDA 510 may be installed on and execute on the individual physical or virtual machine that is hosting the resources. In embodiments, VDA 510 serves as an agent that allows the machine and the resources hosted by the machines to be made available to users. VDA 510 enables users to connect to the resources (e.g., applications) being hosted on the machine. To this end, VDA 510 is configured to provide various virtual desktop access services such as, by way of example, user access authentication and management, user session management, resource brokering and provisioning, and application of policies configured for the session.

In some embodiments, VDA 510 is configured to determine a type of computing device (e.g., mobile device or non-mobile device) that is being used by a user to interact with a resource. For example, VDA 510 may determine the type of computing device that is being used from the user session information (e.g., the type of client agent executing on the computing device or the keyboard settings established for the user session). If a determination is made that the user is using a non-mobile device (e.g., a computing device that provides a physical keyboard), VDA 510 may monitor the keyboard inputs for keyboard inputs that represent shortcuts. Upon detecting a keyboard input that represents a shortcut, VDA 510 may send or otherwise provide the information related to the shortcut to shortcut service 512. For example, for the individual shortcuts that are detected, VDA 510 may provide the shortcut information (e.g., description of the shortcut and the keystroke or keystrokes that are input to initiate the shortcut), a user identifier (user ID) that uniquely identifies the user, an application identifier (app ID) that uniquely identifies the application into which the shortcut is input, and, optionally, information describing the context related to the use of the shortcut to shortcut service 512. As an example, the contextual information may indicate a sequence of one or more keystrokes which proceeded the shortcut. As another example, the contextual information may indicate the content operated on by the shortcut. For instance, contextual information related to a ‘cut’ shortcut may indicate that the text string “abcd” was the text that was cut, deleted, or otherwise removed by the ‘cut’ shortcut action. As still another example, the contextual information may indicate a current state of the application when the shortcut was used. For instance, contextual information may indicate that a text string is selected. As another example, contextual information may indicate that a cursor is currently located in a table, which may be an indication that the user may perform a table operation. Providing this shortcut information and, optionally, the contextual information, enables shortcut service 512 to maintain a record of the shortcuts used by a user when interacting with a specific application.

In some embodiments, shortcut service 512 is configured to generate shortcut configuration files that include shortcut mapping information. In some such embodiments, a file (e.g., a shortcut configuration file) may be specific to a user and an application in that it includes the mappings for the shortcuts used by the user when interacting with the application, as well as other information related to the shortcuts. For example, based on the provided information related to a shortcut, shortcut service 512 may determine whether a shortcut configuration file exists for the indicated user (e.g., user ID) and the indicated application (e.g., app ID). If it is determined that shortcut configuration file does not exist, shortcut service 512 may generate a shortcut configuration file for the indicated user and the indicated application. Shortcut service 512 may then record a shortcut mapping for the indicated shortcut (i.e., a mapping between the shortcut and the one or more keystrokes that are input to initiate the shortcut) in the shortcut configuration file. Otherwise, if it is determined that shortcut configuration file does exist, shortcut service 512 may check the recorded shortcut mappings to determine whether the shortcut configuration file already includes a mapping for the indicated shortcut. If it is determined that the shortcut configuration file does not include a mapping for the indicated shortcut (i.e., a shortcut mapping for the indicated shortcut does not exist), shortcut service 512 may record a shortcut mapping for the indicated shortcut in the shortcut configuration file. Otherwise, if it is determined that the shortcut configuration file includes a mapping for the indicated shortcut (i.e., there is a recorded shortcut mapping for the indicated shortcut), shortcut service 512 may check the recorded shortcut mapping with the received shortcut information to determine whether the recorded shortcut mapping is consistent (i.e., the same) with the received shortcut information. If it is determined that the recorded shortcut mapping is not consistent with or otherwise does not match the received shortcut information, shortcut service 512 may update the recorded shortcut mapping to be consistent with or otherwise match the received shortcut information. For example, the received shortcut information may be for a user-defined shortcut (i.e., a shortcut that is created by the user) that the user changed subsequent to initially creating the shortcut. For instance, the user may have created a shortcut that is initiated by inputting two keystrokes, a keystroke on an ‘CTRL’ key and a keystroke on an ‘A’ key, at the same time. Subsequent to creating this shortcut, the user may have changed this shortcut to be initiated by inputting three keystrokes, a keystroke on an ‘CTRL’ key, a keystroke on an ‘A’ key, and a keystroke on a ‘B’ key, at the same time. In this case, shortcut service 512 may update the recorded mapping for this shortcut from input of a keystroke on an ‘CTRL’ key and a keystroke on an ‘A’ key at the same time to input of a keystroke on an ‘CTRL’ key, a keystroke on an ‘A’ key, and a keystroke on a ‘B’ key at the same time.

In some embodiments, shortcut service 512 may determine a frequency with which the shortcuts are utilized by the user. For example, shortcut service 512 may maintain a count of the number of times a shortcut is used by the user. Based on this information, shortcut service 512 may record frequency-related information along with the shortcut mapping in the shortcut configuration file. As an example, shortcut service 512 may record information that indicates whether the shortcut is (or is not) a favorite shortcut of the user. As another example, shortcut service 512 may record information that indicates a location or position in the virtual keyboard for presenting a shortcut key that represents the shortcut. For example, based on the frequency of use, the shortcut key may be presented at a “prominent” location or position (e.g., a more accessible location such as a location closer to an edge of the virtual keyboard) in the virtual keyboard. As still another example, shortcut service 512 may record information that indicates a size of a shortcut key that represents the shortcut.

In some embodiments, based on the provided information related to a shortcut, shortcut service 512 may make predictions regarding the shortcut. Shortcut service 512 may then record the generated predictions along with the shortcut mapping in the shortcut configuration file. As an example, shortcut service 512 may predict a next shortcut or shortcuts to present subsequent to the user using a shortcut. As another example, shortcut service 512 may predict when to present a shortcut in the virtual keyboard. Shortcut service 512 may make such predictions with use of one or more existing prediction techniques, such as next word prediction in natural language processing (NLP), machine learning (e.g., k nearest neighbors), and other suitable prediction techniques. For example, shortcut service 512 may apply machine learning techniques to look at the last few shortcuts used by the user and compare these shortcuts to all groups of shortcuts used during a training phase. Here, the output of the machine learning technique is a context-sensitive prediction of the shortcut that is most likely to follow groups of similar shortcuts. In some embodiments, based on the shortcuts that have been frequently used by the user, shortcut service 512 may restrict the possible predictions of the next shortcut to the shortcuts that have already been used by the user. For example, if the user has never used the ‘cut’ shortcut after using the ‘delete’ shortcut, it may not make sense to predict the ‘cut’ shortcut to be the next shortcut following the use of the ‘delete’ shortcut.

Referring again to VDA 510, if a determination is made that the user is using a mobile device (e.g., a computing device that does not provide a physical keyboard) to interact with a resource (e.g., an application), VDA 510 may retrieve or otherwise obtain from shortcut service 512 a shortcut configuration file that is specific to the user and the application. As described previously, this shortcut configuration file records the shortcuts which were used by the user when the user previously used the application using a physical keyboard (e.g., a physical keyboard provided by a non-mobile device). VDA 510 may then send or otherwise provide the retrieved shortcut configuration file to the mobile device. Based on the provided shortcut configuration file, the mobile device can present one or more shortcuts in a virtual keyboard for use by the user.

By way of an example, and with continued reference to FIG. 5, user 508 may use resource access application 424 on client device 502 and connect to resource management services 402 to access an application (e.g., MICROSOFT Word application) that is being provided by VDA 510. Upon user 508 establishing a user session with VDA 510, VDA 510 may determine that client device 502 is not a mobile device. In other words, VDA 510 may determine that user 508 is using a non-mobile device to access the MICROSOFT Word application. Upon making this determination, VDA 510 may monitor the keyboard inputs made by user 508 during the user session using the MICROSOFT Word application for keyboard inputs that represent shortcuts. For example, resource access application 424 on client device 502 may send the keyboard inputs made by user 508 to VDA 510. Upon detecting a shortcut, VDA 510 may send information related to the detected shortcut to shortcut service 512 to be recorded for later use, for example. Shortcut service 512 may record the use of the detected shortcut in a shortcut configuration file (e.g., a shortcut configuration file 512a), as described herein. Here, shortcut configuration file 512a records the shortcuts used by user 508 when interacting with the MICROSOFT Word application using a non-mobile device.

At some later time, user 508 may use resource access application 424 on mobile device 504 and connect to resource management services 402 to access the MICROSOFT Word application that is being provided by VDA 510. Upon user 508 establishing a user session with VDA 510, VDA 510 may determine that mobile device 502 is a mobile device. In other words, VDA 510 may determine that user 508 is using a virtual keyboard provided by a mobile device to access or otherwise interact with the MICROSOFT Word application. Upon making this determination, VDA 510 may retrieve shortcut configuration file 512a from shortcut service 512, for example, and send the retrieved retrieve shortcut configuration file 512a to mobile device 504. Based on the provided shortcut configuration file 512a, mobile device 504 may present one or more shortcuts in a virtual keyboard, as described herein. For example, resource access application 424 on mobile device 504 may present the shortcuts in a virtual keyboard that is displayed on a screen of mobile device 508 for use by user 508 in interacting with the MICROSOFT Word application.

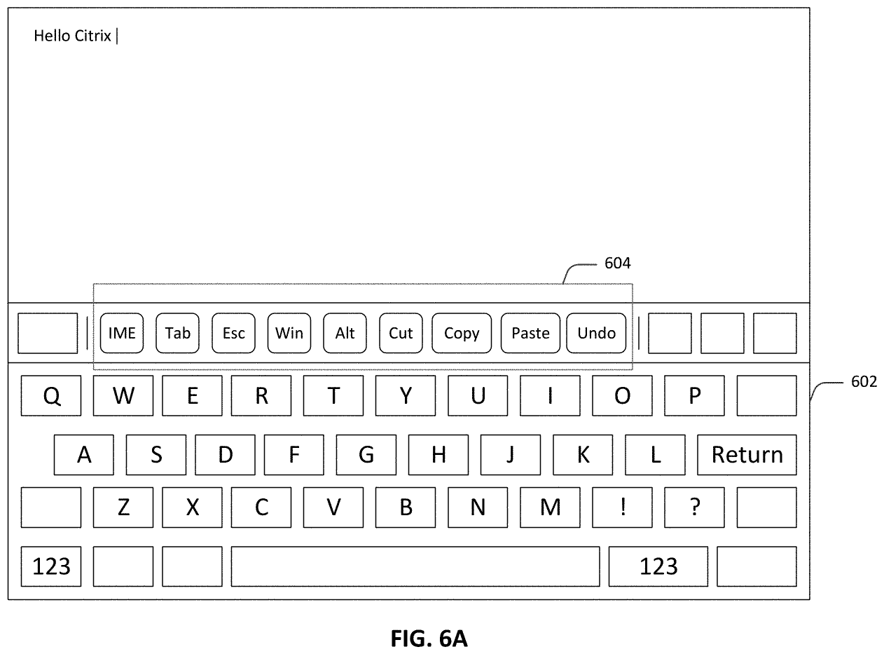

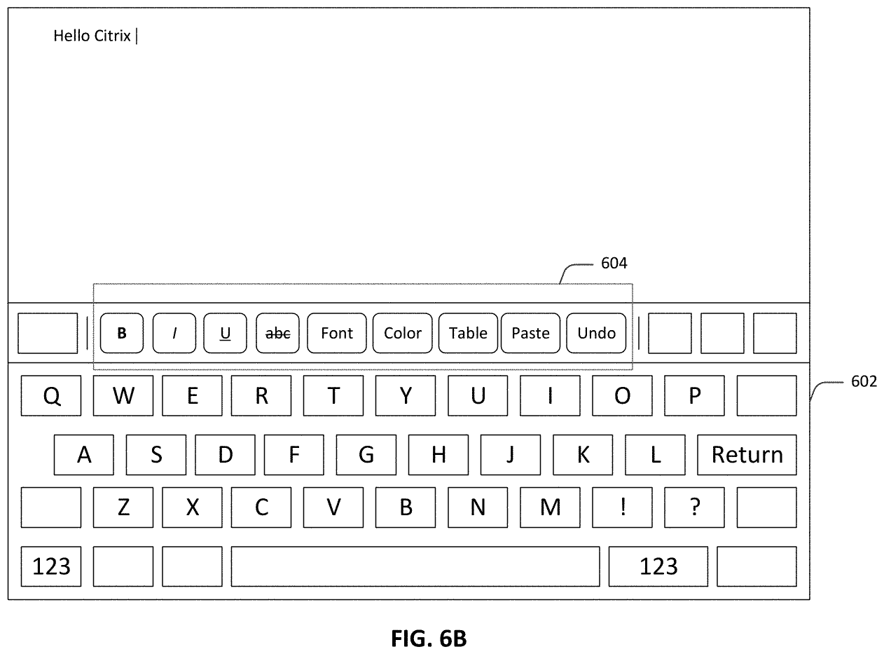

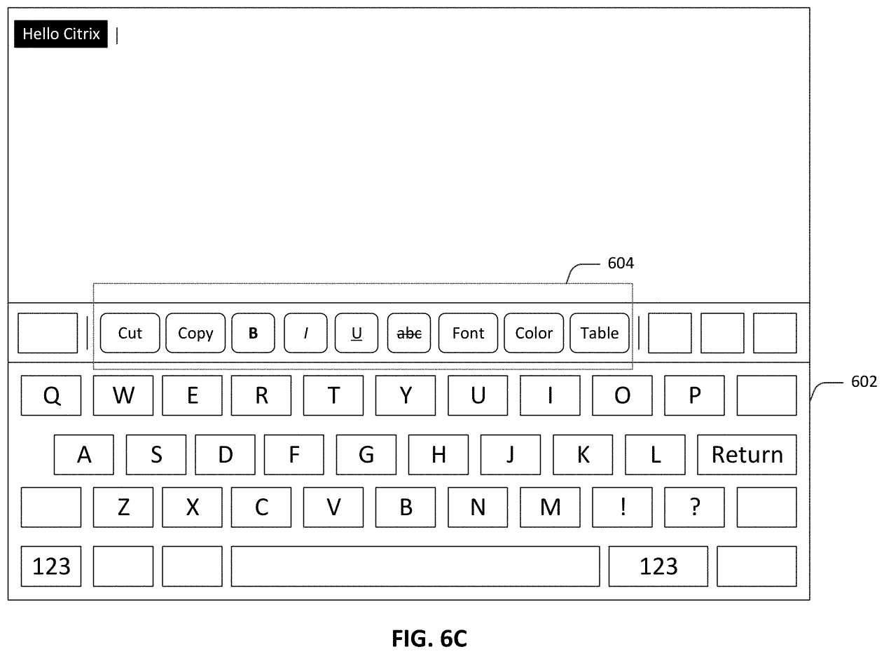

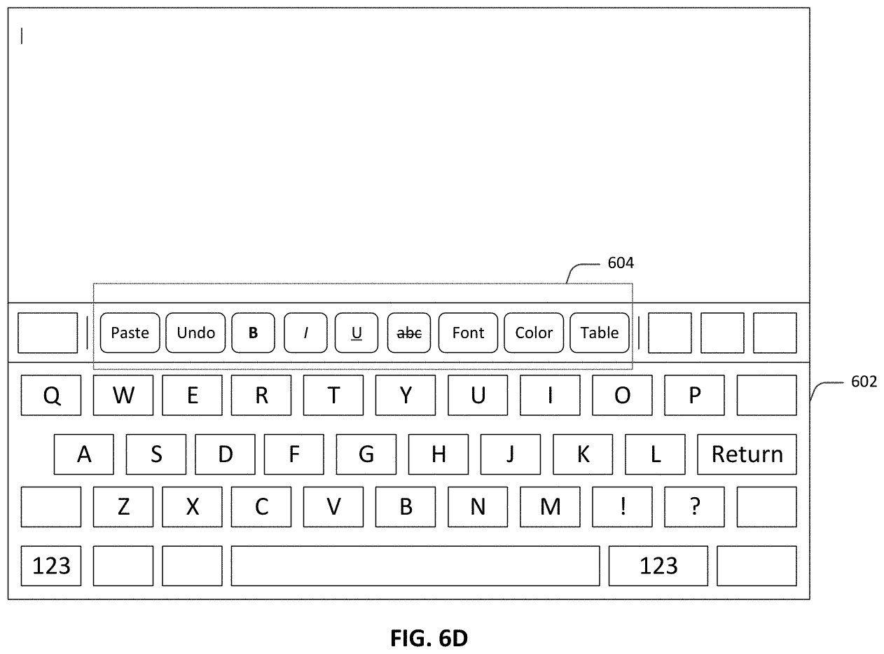

FIGS. 6A-6D illustrate presenting of shortcut keys in a virtual keyboard, in accordance with an embodiment of the present disclosure. With continued reference to the above example, user 508 may use resource access application 424 on mobile device 504 to connect to resource management services 402. Upon user 508 connecting to resource management services 402, resource access application 424 may provide a virtual keyboard 602, as shown in FIG. 6A. Virtual keyboard 602 may be a default mobile device keyboard that is made available to resource access application 424 and which is displayed on a screen of mobile device 504 for use by user 508. As can be seen in FIG. 6A, virtual keyboard 602 may include a toolbar or other key display area 604 that displays multiple keys representative of keyboard or shortcut functions. The keys displayed in toolbar 604 may represent the keyboard functions that are generally provided by resource access application 424. Specifically, toolbar 604 displays an ‘IME’ key, a ‘Tab’ key, an ‘Esc’ key, a ‘Win’ key, an ‘Alt’ key, a ‘Cut’ key, a ‘Copy’ key, a ‘Paste’ key, and an ‘Undo’ key. Note that none, some, or all of the keys displayed in toolbar 604 may be a shortcut key that represents a shortcut.

User 508 may then use virtual keyboard 602 to open (i.e., access) the MICROSOFT Word application, which may be a word processing application provided by resource management services 402. Upon user 508 successfully opening the MICROSOFT Word application, one or more of the keys displayed in toolbar 604 of virtual keyboard 602 may be updated, as shown in FIG. 6B. For example, resource access application 424 on mobile device 504 may present one or more shortcut keys based on information related to the user's (user 508) prior use of the MICROSOFT Word application. Specifically, as can be seen in FIG. 6B, resource access application 424 may present a ‘ [symbol] ’ shortcut key, an “/” shortcut key, a ‘U’ shortcut key, an ‘ [symbol] ’ shortcut key, a ‘Font’ shortcut key, a ‘Color’ shortcut key, a ‘Table’ shortcut key, a ‘Paste’ shortcut key, and an ‘Undo’ shortcut key. For example, the presented shortcut keys may represent shortcuts which were most frequently used (e.g., favorite shortcuts) by user 508 during the user's prior user sessions using the MICROSOFT Word application. These shortcut keys may replace the keys that were previously presented in toolbar 604 (as shown in FIG. 6A) prior to the opening of the MICROSOFT Word application by user 508. Note that two of the keys, the ‘Paste’ shortcut key and the ‘Undo’ shortcut key may be keys which were previously provided in virtual keyboard 602.

As shown in FIG. 6B, user 508 may enter keystrokes on virtual keyboard 602 to input the text string “Hello Citrix”. User 508 may then enter one or more keystrokes on virtual keyboard 602 to select the text string “Hello Citrix”, as shown in FIG. 6C. In response to the selection of the text string “Hello Citrix”, as can be seen in FIG. 6C, resource access application 424 on mobile device 504 may present a ‘Cut’ shortcut key and a ‘Copy’ shortcut key in virtual keyboard 602. For example, the ‘Cut’ shortcut key and the ‘Copy’ shortcut key may represent shortcuts (e.g., a cut shortcut and a copy shortcut) which are predicted to be used by user 508 subsequent to selecting text while using the MICROSOFT Word application. As shown in FIG. 6C, the ‘Cut’ shortcut key and the ‘Copy’ shortcut key may replace the previously presented ‘Paste’ and ‘Undo’ shortcut keys. For example, the ‘Paste’ and ‘Undo’ shortcut keys may be the two shortcut keys of the previously presented shortcut keys which were least recently used by user 508. In an embodiment, the ‘Cut’ shortcut key and the ‘Copy’ shortcut key may be presented at prominent locations in virtual keyboard 602. Such prominent locations may be locations in virtual keyboard 602 which allow for easy access. For example, as can be seen in FIG. 6C, the ‘Cut’ shortcut key and the ‘Copy’ shortcut key may be presented at the first two locations in toolbar 604 of virtual keyboard 602.

Continuing the above example, user 508 may use the ‘Cut’ shortcut key presented in virtual keyboard 602 to cut the selected text string “Hello Citrix”. In response, as can be seen in FIG. 6D, resource access application 424 on mobile device 504 may present a ‘Paste’ shortcut key in virtual keyboard 602. For example, the ‘Paste’ shortcut key may represent a shortcut (e.g., a paste shortcut) which is predicted to be used by user 508 subsequent to cutting text while using the MICROSOFT Word application. As shown in FIG. 6D, the ‘Paste’ shortcut key may replace the previously presented ‘Cut’ shortcut key. For example, the cut shortcut represented by the ‘Cut’ shortcut key may be the shortcut that is predicted to be the least likely to be used by user 508 subsequent to cutting text while using the MICROSOFT Word application.

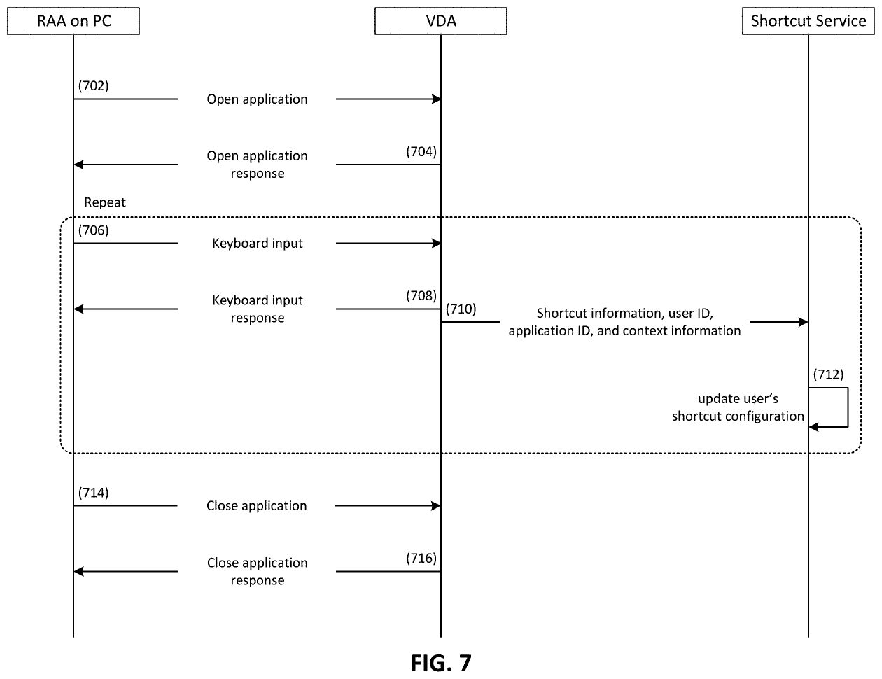

FIG. 7 is a sequence diagram showing an example flow of interactions between various components to generate a shortcut configuration file, in accordance with an embodiment of the present disclosure. For example, with reference to the elements illustrated in FIG. 5, user 508 may provide an input, such as a keyboard input, to resource access application 424 on client device 502 (e.g., a personal computer that provides a physical keyboard) to open (i.e., access) an application, such as a spreadsheet application, provided by resource management services 402. In response to the provided input, resource access application 424 on client device 502 may send (702) a request to open the application to VDA 510 that is providing the requested application. In response to the request, VDA 510 may open the requested application and send (704) a response to resource access application 424 on client device 502 to indicate that the requested application is opened. VDA 510 may also check and determine that client device 502 is not a mobile device.

Upon opening the application, user 508 may make a keyboard input (e.g., one or more keystrokes) to perform an action using the application. To cause the action to be performed by the application, resource access application 424 on client device 502 may send (706) the keyboard input to VDA 502. VDA 502 may then pass the received keyboard input to the application for processing. Upon the action being performed by the application, VDA 502 may send (708) a response to resource access application 424 on client device 502 that indicates or otherwise shows the performance of the action. Upon receiving the keyboard input, VDA 502 may also check the keyboard input to determine whether the keyboard input represents a shortcut. If it is determined that the keyboard input represents a shortcut, VDA 502 may send (710) shortcut information (e.g., a description of the shortcut and the keystroke(s) that are input to initiate the shortcut), a user ID of user 508, and an app ID that identifies the application to shortcut service 512. In some embodiments, VDA 502 may also send additional information that describes the context related to the use of the shortcut to shortcut service 512. Upon receiving the information related to the shortcut, shortcut service 512 may update (712) the shortcut configuration information related to the user's (user 508) use of the application. For example, shortcut service 512 may record or update a shortcut mapping for the indicated shortcut, for example, in a shortcut configuration file that is specific to user 508 and the application. Shortcut service 512 may also record frequency-related information related to the shortcut and/or information related to predictions regarding the shortcut. Iterations 706-712 may be repeated as necessary to process further keyboard inputs made by user 508 to perform actions using the application.

When user 508 is finished using the application, user 508 may provide an input, such as a keyboard input, to resource access application 424 on client device 502 to close (i.e., no longer access) the application. In response to the provided input, resource access application 424 on client device 502 may send (714) a request to close the application to VDA 510. In response to the request, VDA 510 may close the indicated application and send (716) a response to resource access application 424 on client device 502 to indicate that the application is closed.

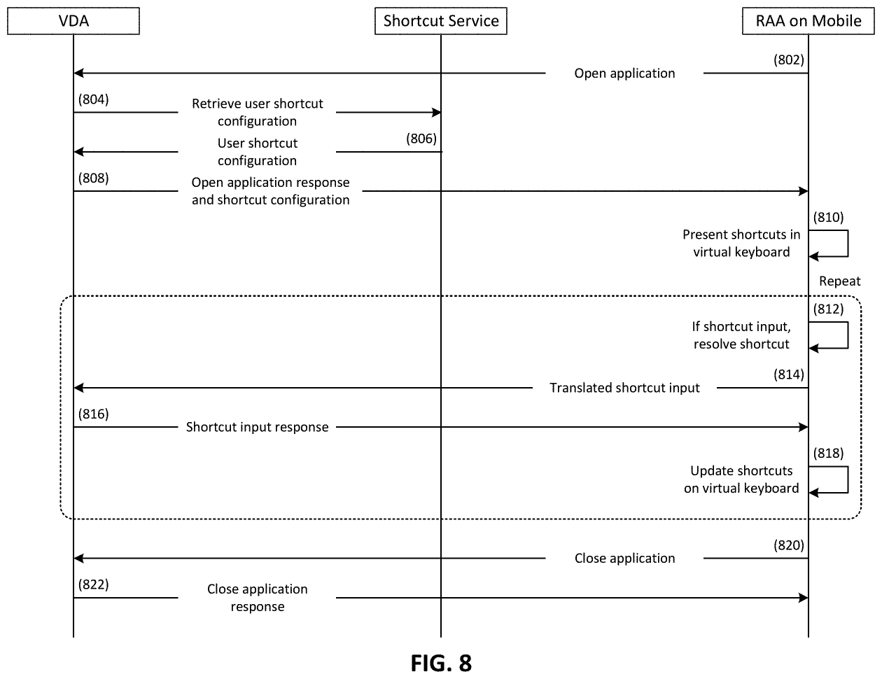

FIG. 8 is a sequence diagram showing an example flow of interactions between various components to present shortcut keys in a virtual keyboard, in accordance with an embodiment of the present disclosure. For example, with reference to the elements illustrated in FIG. 5, user 508 may provide an input, such as a keyboard input, to resource access application 424 on mobile device 504 (e.g., a tablet computer) to open (i.e., access) an application, such as a spreadsheet application, provided by resource management services 402. In this example, user 508 may have previously used the application using a computing device that provides a physical keyboard and may now want to use the application using a mobile device. In response to the provided input, resource access application 424 on mobile device 504 may send (802) a request to open the application to VDA 510 that is providing the requested application. In response to the request, VDA 510 may check and determine that device 504 is a mobile device. Upon the determination that device 504 is a mobile device, VDA 510 may send (804) a request to shortcut service 512 retrieve a shortcut configuration file that is applicable to user 508 and the application that is being opened by user 508. In response to the request, shortcut service 512 may send (806) the requested shortcut configuration file (e.g., shortcut configuration file 512a) to VDA 510. VDA 510 may then open the requested application and send (808) the retrieved shortcut configuration file with a response to resource access application 424 on client device 502 to indicate that the requested application is opened. Upon receiving the shortcut configuration file, resource access application 424 on client device 502 may present (810) one or more shortcuts in a virtual keyboard based on the information contained in the shortcut configuration file. User 508 may then use the virtual keyboard, including the shortcuts presented in the virtual keyboard, to interact with the opened application.

Resource access application 424 on mobile device 504 may then monitor the keyboard inputs on mobile device 504 for the use of shortcuts which were provided based on the shortcut configuration file. If such an input on a shortcut is detected, resource access application 424 may intercept the keyboard input that represents the shortcut and resolve (812) the intercepted shortcut. For example, resource access application 424 may translate the shortcut into one or more keystrokes based on the shortcut mapping information in the shortcut configuration file. Resource access application 424 on mobile device 504 may then send (814) the translated shortcut (i.e., the one or more keystrokes that are mapped to the shortcut) to VDA 502. For example, suppose that use of a ‘bold’ shortcut is intercepted, and that the shortcut mapping information indicates a mapping between the ‘bold’ shortcut and the combination of the ‘CTRL’ key and the ‘B’ key. That is, the ‘bold’ shortcut can be initiated by pressing the ‘CTRL’ key and the ‘B’ key. In this example case, upon detecting the use of the ‘bold’ shortcut, resource access application 424 may translate the intercepted keyboard input (e.g., an input of the ‘B’ shortcut key of FIGS. 6B-6D) to an input of a keystroke on the ‘CTRL’ key and a keystroke on the ‘B’ key, and send an indication of an input of these two keystrokes to VDA 502.

Upon receiving the keystrokes which are mapped to the shortcut, VDA 502 may pass the received keystrokes to the application for processing of the shortcut. Upon the shortcut action being performed by the application, VDA 502 may send (816) a response to resource access application 424 on mobile device 504 that indicates or otherwise shows the performance of the shortcut action. Note that, resource access application 424 on mobile device 504 also processes the other keyboard inputs (i.e., the keyboard inputs other than the shortcuts that are based on the shortcut configuration file) that are input by user 508 to perform various actions using the application.

At 818, resource access application 424 on mobile device 504 may update the presentation of the shortcuts in the virtual keyboard upon receipt of the received shortcut input response. For example, based on information in the shortcut configuration file, resource access application 424 on mobile device 504 may reposition one or more of the shortcut keys presented in the virtual keyboard after performance of a shortcut operation. As another example, based on information in the shortcut configuration file, resource access application 424 on mobile device 504 may display a new shortcut key which was previously not displayed in the virtual keyboard that might likely be used in performance of action subsequent to initiation or completion of a previous shortcut operation. Iterations 812-818 may be repeated as necessary to process further keyboard inputs made by user 508 to perform actions using the application.

When user 508 is finished using the application, user 508 may provide an input, such as a keyboard input, to resource access application 424 on mobile device 504 to close (i.e., no longer access) the application. In response to the provided input, resource access application 424 on mobile device 504 may send (820) a request to close the application to VDA 510. In response to the request, VDA 510 may close the indicated application and send (822) a response to resource access application 424 on mobile device 504 to indicate that the application is closed.

### Further Example Embodiments

The following examples pertain to further embodiments, from which numerous permutations and configurations will be apparent.

Example 1 includes a method including: responsive to initiation, by a computing device, of an application of the computing device, a display of which including a virtual keyboard, detecting, by the computing device, an input on a shortcut key of the virtual keyboard; translating, by the computing device, the shortcut key into one or more keystrokes based on a configuration file for that short key; and providing, by the computing device, the one or more keystrokes to the application to execute a function of the shortcut key in response to the detected input.

Example 2 includes the subject matter of Example 1, further comprising updating, by the computing device, a position of the shortcut key presented in the virtual keyboard in response to the detected input on the shortcut key.

Example 3 includes the subject matter of any of Examples 1 and 2, further comprising updating, by the computing device, a layout of the one or more shortcut keys presented in the virtual keyboard in response to the detected input on the shortcut key.

Example 4 includes the subject matter of any of Examples 1 through 3, wherein the shortcut configuration file is associated with both a user of the application and the application.

Example 5 includes the subject matter of any of Examples 1 through 4, wherein the shortcut configuration file includes a mapping of one or more past shortcuts, the one or more past shortcuts being input during a prior use of the application.

Example 6 includes the subject matter of Example 5, wherein the prior use of the application was on a computing device that included a non-virtual keyboard.

Example 7 includes the subject matter of any of Examples 1 through 6, wherein the configuration file is received in response to opening the application using the computing device.

Example 8 includes the subject matter of any of Examples 1 through 7, wherein the shortcut key is a user created shortcut key.

Example 9 includes the subject matter of any of Examples 1 through 8, wherein the computing device is a mobile device.

Example 10 includes a mobile computing device including a memory and one or more processors in communication with the memory and configured to: responsive to initiation of an application of the mobile computing device, a display of which includes a virtual keyboard, detect an input on a shortcut key of the virtual keyboard; translate the shortcut key into one or more keystrokes based on a configuration file for that short key; and provide the one or more keystrokes to the application to execute a function of the shortcut key in response to the detected input.

Example 11 includes the subject matter of Example 10, wherein the one or more processors are further configured to update a position of the shortcut key presented in the virtual keyboard in response to the detected input on the shortcut key.

Example 12 includes the subject matter of any of Examples 10 and 11, wherein the one or more processors are further configured to update a layout of the one or more shortcut keys presented in the virtual keyboard in response to the detected input on the shortcut key.

Example 13 includes the subject matter of any of Examples 10 through 12, wherein the shortcut configuration file is associated with both a user of the application and the application.

Example 14 includes the subject matter of any of Examples 10 through 13, wherein the shortcut configuration file includes a mapping of one or more past shortcuts, the one or more past shortcuts being input during a prior use of the application.

Example 15 includes the subject matter of Example 14, wherein the prior use of the application was on a computing device that included a non-virtual keyboard.

Example 16 includes the subject matter of any of Examples 10 through 15, wherein the configuration file is received in response to opening the application using the mobile computing device.

Example 17 includes the subject matter of any of Examples 10 through 16, wherein the shortcut key is a user created shortcut key.

Example 18 includes a method including: receiving, by a computing device, shortcut information and context information, the shortcut information including an indication of a shortcut key and one or more keystrokes that map to the shortcut key, the context information related to a context of the application; generating, by the computing device, a mapping between the shortcut key and the one or more keystrokes in a shortcut configuration file associated with both a user and an application, the mapping including information related to a displaying of the shortcut key; and responsive to a request for the shortcut configuration file, providing, by the computing device, the shortcut configuration file for use in displaying the shortcut key on a virtual keyboard.

Example 19 includes the subject matter of Example 18, wherein the information related to the displaying of the shortcut key indicates when the shortcut key is to be presented in the virtual keyboard.

Example 20 includes the subject matter of any of Examples 18 and 19, wherein the information related to the displaying of the shortcut key indicates a position of the shortcut key in the virtual keyboard.

Example 21 includes a system including a memory and one or more processors in communication with the memory and configured to: receive shortcut information and context information, the shortcut information including an indication of a shortcut key and one or more keystrokes that map to the shortcut key, the context information related to a context of the application; generate a mapping between the shortcut key and the one or more keystrokes in a shortcut configuration file associated with both a user and an application, the mapping including information related to a displaying of the shortcut key; and responsive to a request for the shortcut configuration file, provide the shortcut configuration file for use in display of the shortcut key on a virtual keyboard.

Example 22 includes the subject matter of Example 21, wherein the information related to the display of the shortcut key indicates when the shortcut key is to be presented in the virtual keyboard.

Example 23 includes the subject matter of any of Examples 21 and 22, wherein the information related to the display of the shortcut key indicates a position of the shortcut key in the virtual keyboard.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

1. A method comprising:
responsive to access, by a computing device, of an application
sending, by the computing device, a request to open the application on a remote machine, the remote machine configured to retrieve, from a shortcut service, a configuration file including a mapping of one or more shortcuts recorded during prior use of the application on another remote machine based on monitoring of keyboard inputs to the application, the prior use of the application being by another computing device that included a non-virtual keyboard, the prior use of the application being by a user that is associated with the computing device accessing the application, the shortcut service being separate from both the remote machine and the another remote machine;
receiving, by the computing device, a response from the remote machine indicating that the application is opened, the response including the configuration file;
presenting, by the computing device, one or more shortcut keys within a virtual keyboard based on a configuration file;
detecting, by the computing device, an input on a shortcut key of the one or more shortcut keys within the virtual keyboard;
translating, by the computing device, the shortcut key into one or more keystrokes based on the configuration file; and
providing, by the computing device, the one or more keystrokes to the application on the remote machine to execute a function of the shortcut key in response to the detected input.

2. The method of claim 1, further comprising updating, by the computing device, a position of the shortcut key presented in the virtual keyboard in response to the detected input on the shortcut key.

3. The method of claim 1, further comprising updating, by the computing device, a layout of one or more shortcut keys presented in the virtual keyboard in response to the detected input on the shortcut key.

4. The method of claim 1, wherein the configuration file is associated with both the user and the application.

5-7. (canceled)

8. The method of claim 1, wherein the shortcut key is a user created shortcut key.

9. The method of claim 1, wherein the computing device is a mobile device.

10. A mobile computing device comprising:
a memory; and
one or more processors in communication with the memory and configured to, responsive to access of an application of the mobile computing device
send, by the computing device, a request to open the application on a remote machine, the remote machine configured to retrieve, from a shortcut service, a configuration file including a mapping of one or more shortcuts recorded during prior use of the application on another remote machine based on monitoring of keyboard inputs to the application, the prior use of the application being by another computing device that included a non-virtual keyboard, the prior use of the application being by a user that is associated with the computing device accessing the application, the shortcut service being separate from both the remote machine and the another remote machine;
receive, by the computing device, a response from the remote machine indicating that the application is opened, the response including the configuration file;
present, by the computing device, one or more shortcut keys within a virtual keyboard based on a configuration file;
detect an input on a shortcut key of the one or more shortcut keys within the virtual keyboard;
translate the shortcut key into one or more keystrokes based on the configuration file; and
provide the one or more keystrokes to the application on the remote machine to execute a function of the shortcut key in response to the detected input.

11. The device of claim 10, wherein the one or more processors are further configured to update a position of the shortcut key presented in the virtual keyboard in response to the detected input on the shortcut key.

12. The device of claim 10, wherein the one or more processors are further configured to update a layout of the one or more shortcut keys presented in the virtual keyboard in response to the detected input on the shortcut key.

13. The device of claim 10, wherein the configuration file is associated with both the user and the application.

14-16. (canceled)

17. The device of claim 10, wherein the shortcut key is a user created shortcut key.

18. A method comprising:
receiving, by a computing device, shortcut information and context information, the shortcut information including an indication of a shortcut key and one or more keystrokes that map to the shortcut key, the context information related to a context of the application;
generating, by the computing device, a mapping between the shortcut key and the one or more keystrokes in a shortcut configuration file associated with both a user and an application, the mapping including information related to a displaying of the shortcut key; and
responsive to a request for the shortcut configuration file, providing, by the computing device, the shortcut configuration file for use in displaying the shortcut key on a virtual keyboard.

19. The method of claim 18, wherein the information related to the displaying of the shortcut key indicates when the shortcut key is to be presented in the virtual keyboard.

20. The method of claim 18, wherein the information related to the displaying of the shortcut key indicates a position of the shortcut key in the virtual keyboard.

21-22. (canceled)

23. The method of claim 1, wherein the remote machine is configured to retrieve the configuration file from the shortcut service and send the configuration file to the computing device responsive to a determination that the computing device is a mobile computing device.

24. The method of claim 1, wherein the presenting of the one or more shortcut keys within the virtual keyboard based includes presenting shortcut keys within the virtual keyboard representing shortcuts which were most frequently used during the prior use of the application.

25. The method of claim 24, wherein the information about which shortcuts were most frequently used during prior use of the application is determined by the shortcut service and recorded within the configuration file.

26. The device of claim 10, wherein the remote machine is configured to retrieve the configuration file from the shortcut service and send the configuration file to the computing device responsive to a determination that the computing device is a mobile computing device.

27. The device of claim 10, wherein the presenting of the one or more shortcut keys within the virtual keyboard based includes presenting shortcut keys within the virtual keyboard representing shortcuts which were most frequently used during the prior use of the application.

28. The device of claim 27, wherein the information about which shortcuts were most frequently used during prior use of the application is determined by the shortcut service and recorded within the configuration file.
